(19) United States
(12) Patent Application Publication
(10) Pub. No.: US 2008/0229875 A1
(43) Pub. Date: Sep. 25, 2008

(54) Clipless bicycle pedal systems

(76) Inventor: Charles D. Ray, Shrewsbury, MA (US)

Correspondence Address: Nields & Lemack, 176 E. Main Street, Suite #5, Westboro, MA, 01581, US

(21) Appl. No.: 12/077,362

(22) Filed: Mar. 19, 2008

Related U.S. Application Data
(60) Provisional application No. 60/919,154, filed on Mar. 22, 2007.

(51) Int. Cl. B62M 3/08

(52) U.S. Cl. 74/594.6

(57) ABSTRACT

A system and method for improving the engagement reliability of a clipless pedal system is disclosed. Briefly, a magnetic material is positioned near the critical engagement point on the pedal. A ferrous material is added to the front edge of the cleat, such that this edge of the cleat is attracted toward the magnetic material, thereby simplifying the engagement process. In certain embodiments, the magnetic material is placed on a biasing element, such that it has an operative and stowed position. In other embodiments, the magnetic material is fixed in location.

This application claims priority of U.S. Provisional Patent Application No. 60/919,154, filed on Mar. 22, 2007, the disclosure of which is incorporated herein by reference.

### BACKGROUND OF THE INVENTION

Clipless bicycle pedal systems, such as those disclosed in U.S. Pat. Nos. 4,928,549 and 5,203,229, are a commonly known means of improving pedaling efficiency. In contrast to traditional pedals, these systems are typically comprised of a retaining mechanism integrated with a bicycle pedal and a complementary cleat that is affixed to the bottom of the cyclist shoe, approximately centered below the ball of the rider's foot. The retaining mechanism captures the shoe cleat after the engagement criteria are met, thereby mating the bicycle pedal and the rider's shoe. When the cleat is captured in the pedal retaining mechanism, the rider can apply force throughout the 360 degrees of rotation. This continuous application of force is not possible with conventional bicycle pedals, since the shoe and the pedal are not coupled.

The captive cleat is one of the primary objectives of clipless pedal systems. In the clipless pedal system, there is typically one cleat for each shoe and at least one retaining mechanism within each pedal. This system is used widely by intermediate and advanced bicyclist to help them improve pedaling performance and cycling control.

In normal operation, the cyclist or rider places the cleat, located on the bottom of the shoe, into a first engagement point on the retaining mechanism of the pedal. This process of engagement is commonly referred to as “clipping-in”, and this term will be used throughout this document to refer to the engagement process. Typically, clipping-in is a two step process, which must be repeated for each cleat. The first step requires the rider to properly engage the cleat with the first engagement point. Once this is accomplished, the second and final step of the engagement process can be completed.

FIG. 7a shows a clipless pedal system of the prior art. In some embodiments, the cleat 13 is a protrusion at the bottom of the shoe 45. This protrusion 13 may comprise a stem 100 and two protruding tabs; a forward tab 102 (toward the cyclist's toe) and a rear tab 103 (toward the cyclist's heel). The protruding tabs are captured by the retaining mechanism of the pedal 10. In this Figure, the retaining mechanism has two portions, a fixed retaining element and a pivoting retaining element. In most embodiments, the fixed retaining element is the forward portion 104, while the pivoting element captures the rear tab. In the embodiment shown in FIG. 7, the fixed retaining element is the forward portion 104, which includes an overhanging portion 105, which is used to hold the front protruding tab of the cleat in place. While this embodiment shows an overhang, this is not required by the invention. Any structure that provides a space into which the protruding tab can be inserted and held in place is suitable. For example, the fixed element may comprise a upside down “U” shape, where the tab is inserted into the space defined between the top and side walls of the element. This space is defined as the first engagement point 120. The pivoting retaining element is the rear portion 106. The front protruding tab 102 of the cleat must be inserted into the space defined by the forward fixed portion 104 and the overhanging portion 105, as shown in FIG. 7b, defined as the first engagement point 120. Once the front tab 102 of the cleat 13 is properly engaged, the cyclist pivots the shoe so as to cause the back tab 103 of the cleat to engage with the rear pivoting portion 106. In this embodiment, the rear pivoting portion 106 moves to allow the rear tab 103 to enter and then snaps back into position so as to lock the cleat in place. The combination of front portion 104, overhanging portion 105 and pivoting rear portion 106 form a captive cage in which the cleat is captured. This configuration is shown in FIG. 7c.

A common complaint about using clipless pedal systems is the difficulty making cleat engagement. The engagement process is often unsuccessful because aligning the shoe cleat with the first engagement point of the retaining mechanism is cumbersome and difficult. Much of the difficulty in making this alignment is due to the cleat's location on the underside of the cyclist's shoes where visual orientation is impossible and tactile alignment is ambiguous at best. In other words, the cyclist cannot see the pedal or the cleat while trying to clip-in. Therefore, successfully clipping-in the retaining mechanism is a blind and cumbersome process, especially for new or infrequent users, and to any user in distracted situations.

Making the engagement of the shoe cleats with the pedal's retaining mechanism (clipping-in) is a learned art by the user. Clipping-in is a matter of training one's mind and body to be sensitive to location and feel during the act of cleat engagement. This learning process may take hundreds or even thousands of attempts by a rider before they can establish any form of reliability with the process. Some riders never establish engagement reliability and abandon clipless pedals for conventional or other retaining pedal systems. Failure to properly align the cleat with the valid entry area for the first engagement on the clipless pedal will result in the cleat being rejected from the captive retaining mechanism. When the cleat is not captive in the retaining mechanism, the rider is limited in his ability to apply force to the pedals to accelerate the bicycle. Failure to establish clip-in engagement could ultimately cause the rider to lose control of the bicycle and create a hazardous situation.

Clearly, an improved system for engaging a cleat to a retaining means of a pedal is needed.

### SUMMARY OF THE INVENTION

The problems of the prior art are solved by the present invention, which improves the engagement reliability of a clipless pedal system by positioning a magnetic presence at the critical engagement location needed for the cleat for functional operation. Briefly, a magnetic material is positioned near the critical engagement point on the pedal. A ferrous material (or a magnet) is added to the front edge of the cleat, such that this edge of the cleat is attracted toward the magnetic material, thereby simplifying the engagement process. In certain embodiments, the magnetic material is placed on a biasing element, such that it has an operative and stowed position. In other embodiments, the magnetic material is fixed in location.

### BRIEF DESCRIPTION OF THE DRAWINGS

FIG. 1 is an exploded perspective view of a partial clipless pedal device depicting the integration of the magnetic alignment target feature within;

FIG. 2A is a top view of a first embodiment of the magnetic target feature mounted in a spring-wire frame assembly;

FIG. 2B is the unassembled view of FIG. 2A;

FIG. 2C is a side view of the assembly depicted in FIG. 2A;

FIG. 2D is a perspective view of a cylindrical magnet target used in this embodiment;

FIG. 3A is a partial exploded side view of a clipless pedal system showing the integration of a magnetic alignment target feature;

FIG. 3B is a top view of an assembled clipless pedal with an embodiment of the invention, a magnetic alignment target, and a mating shoe cleat device;

FIG. 4 is a side view of clipless pedal system including a cyclist's shoe with the mating cleat attached, and the pedal attached to a crank arm.

FIG. 5A is a side view of a simplified clipless pedal system depicting the shoe cleat as it approaches the clipless pedal's first engagement area;

FIG. 5B is a side view of the shoe cleat tip within the magnetic field at the first engagement point;

FIG. 5C is a side view of the shoe cleat after it has made the first and second engagement into the clipless pedal retaining cage area;

FIG. 6A is a side view of a second embodiment of the present invention;

FIG. 6B is a side view of a third embodiment mounting the alignment target in a different location;

FIG. 6C are two views of an alternative spring mounting device for the alignment target;

FIG. 7A shows a clipless pedal system of the prior art;

FIG. 7b shows the system of FIG. 7A as the rider attempts to engage; and

FIG. 7c shows the fully engaged system of the prior art.

### DETAILED DESCRIPTION OF THE DRAWINGS

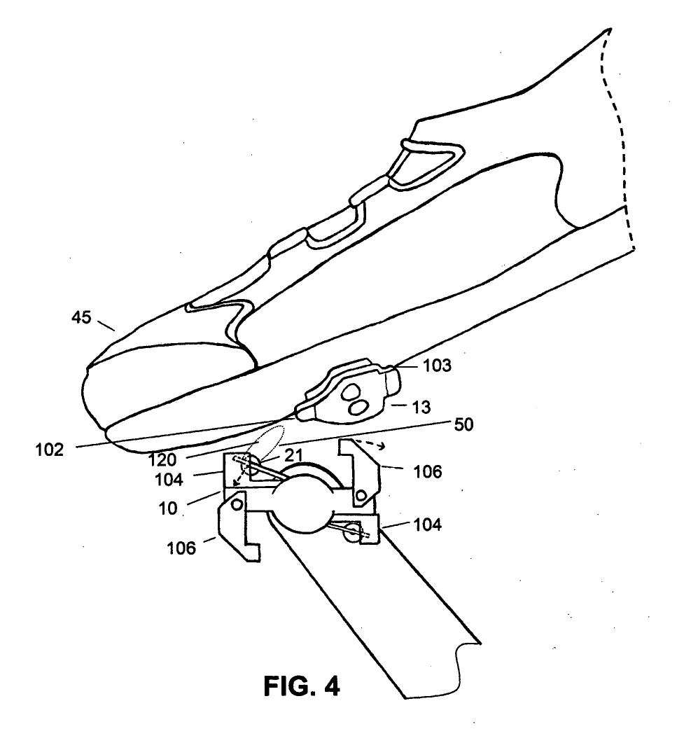

FIG. 4 illustrates the basic operation of the present invention. The figure depicts a clipless pedal system, comprising a shoe cleat 13 attached to a special riding shoe 45 and a corresponding mating bicycle pedal 10. As described above, there is a specific order to be followed to properly engage the cleat and the pedal. The cleat typically includes front and rear protruding tabs 102, 103. The retaining means of the pedal preferably comprise a first retaining element and a second retaining element. In most embodiments, the first retaining element is fixed, while the second retaining element is pivotable. Furthermore, in most embodiment, the fixed retaining element is located forward of the pivoting element, such that the front tab is inserted into the fixed retaining element. Although the description and figures describe the front retaining element as being fixed and the rear retaining element as being pivoting, the invention is not so limited. It is also possible that the rear retaining element is fixed and the front retaining element is pivoting, such that the rear tab of the cleat must be inserted first. In addition, it is possible that the pedal is configured such that the user clips into the pivotable element first, which then extends enough to allow the second tab of the cleat to engage with the second retaining element. It is also possible that this second retaining element is also pivotable, such that the user can clip in to either element first. In all cases, the first engagement point corresponds to the retaining element into which the user first places the cleat.

In FIG. 4, the fixed retaining element is located in front of the pivoting element. The fixed front portion 104 of the retaining means of the pedal and the pivoting rear portion 106 combine to create a capture cage, into which the protruding tabs 102, 103 of the shoe cleat must be inserted.

FIG. 4 shows a side view of the shoe cleat being directed toward the first engagement point 120 by the cyclist. As described earlier, this first engagement point 120 is located near the fixed retainer element, which in this embodiment is the front portion 104 of the retaining means. The front protruding tab 102 of the cleat is moved toward the engagement point 120 by the cyclist. In the preferred embodiment, the front protruding tab 102 is made from a ferrous material or has a magnetic material affixed to it. A target magnet 21 is preferably located at or near the first engagement point 120. The magnetic material (such as a ferrous material or a magnet) located on the cleat is attracted to the target magnet 21, thereby guiding it toward the first engagement point. The front protruding tab 102 of the cleat is drawn toward the target magnet 21 when it is in the magnet's flux field 50.

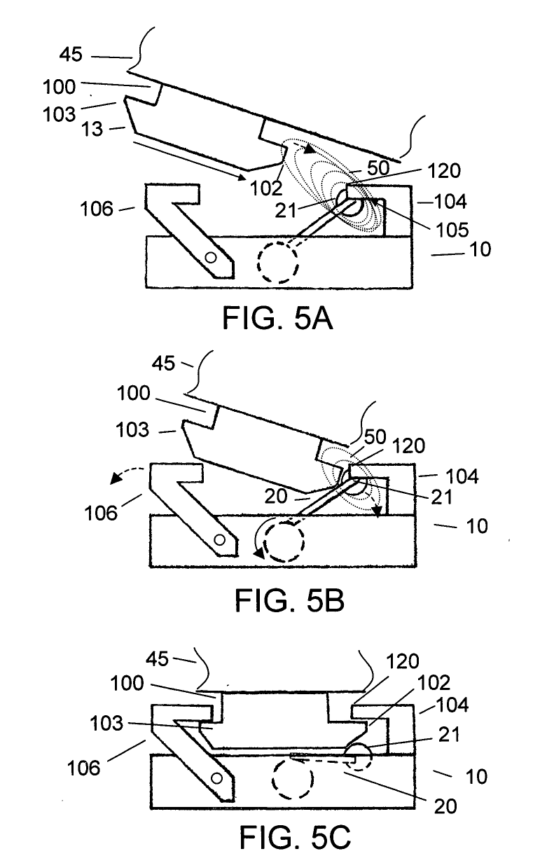

FIGS. 5A through 5C show the sequence as the cleat is engaged with the bicycle pedal. Referring to FIG. 5A, target magnet 21 has an associated field 50, which will attract ferrous materials. This attraction force begins to take effect when the front tab 102 of cleat 13 moves close enough to the pedal so as to enter the magnetic field of flux 50 emanating from the target magnet 21. As is well known in the art, the attraction force increases greatly as the distance between the tab 102 and the target magnet 21 is reduced. Thus, as shown in FIG. 5B, the cleat is pulled toward the target magnet 21 as it draws nearer.

In one embodiment, target magnet 21 is located upon a pivoting rod 20, which is naturally biased toward the first engagement point 120. As the cleat is pressed into the first engagement point, pivoting rod 20 rotates, thereby moving the rod and the target magnet downward and away from the front fixed portion, into a stowed position, as shown in FIG. 5C. It should be noted that the magnetic attraction may cause the pedal 10 to rotate about the crank arm of the bicycle, thus moving the engagement point 120 toward cleat tip 13. Such pedal rotation is not required for the invention to be effective, however it does further enhance the functionality.

FIGS. 5A and 5B are side views of the shoe cleat tab 102 in the magnetic field 50 where the field of flux influences the pedal 10 and shoe cleat 13 to be pulled toward each other. When the tab 102 of the shoe cleat 13 contacts the target magnet 21, the cleat 13 is positioned in a location where the first engagement criterion can be easily accomplished. The cyclist can then apply pressure to the cleat 13 through the shoe 45 with leg actuation engaging the cleat 13 into the cleat capture cage to complete the full cleat engagement. FIG. 5C is the side view of the cleat 13 fully engaged in the captive cage area of the clipless pedal. As described above, the target magnet 21 is pivoted out of the way by the shoe cleat 13. A biasing mechanism, such as a wire spring suspension, which is part of the target assembly 20, will return the target magnet 21 to the first engagement location upon removal of the shoe cleat 13 from the captive cage. Thus, the target magnet 21 will be properly positioned for the next engagement action by the rider.

It is obvious to one of ordinary skill in the art that the distance at which the target magnet 21 causes the pedal to rotate toward the cleat depends on the strength of the magnet, the effective weight of the pedal and the friction of the pedal bearing as well as other environmental and mechanical factors.

Having described the basic operation of the invention, it is important to note that there are a variety of embodiments that can be employed. The following is not intended to be a complete list of all such embodiments; rather it is only intended to demonstrate some of these possibilities.

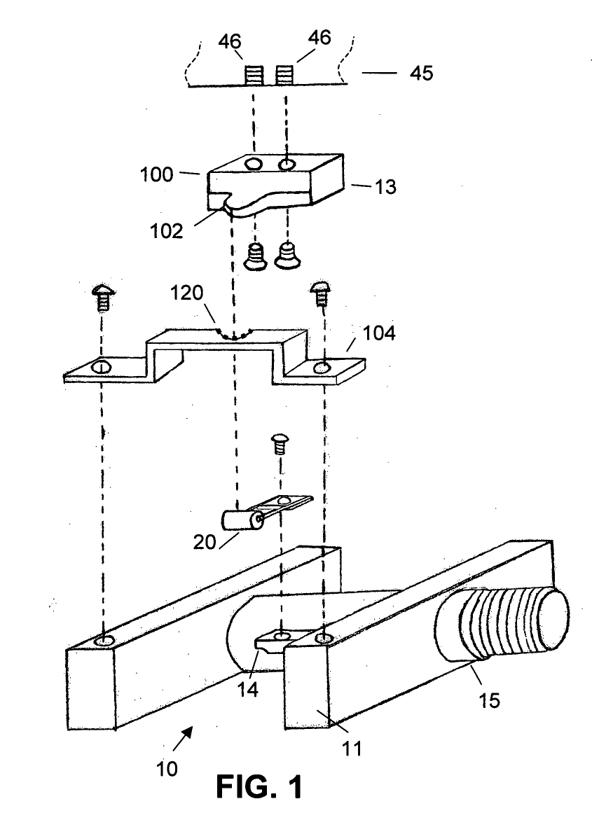

As described above, FIG. 4 uses a bias mechanism, such as a spring wire suspension assembly 20. The suspension assembly 20 is dimensioned such that when it is attached to the mounting platform 14 of the pedal body 11, as seen in FIG. 1, the magnet is positioned at the cleat entry point of the first engagement point 120 of the clipless pedal 10.

FIG. 1 shows a second embodiment of the present invention. Note that only the front portion 104 of the pedal is shown for clarity. As is FIG. 4, in this embodiment, the front portion 104 is the fixed retaining element. Also as is FIG. 4, the cleat 13 has a front protruding tab 102. This cleat is affixed to the bottom of the shoe 45, such as by screws or other suitable fastening devices. Target magnet 21 is affixed to target assembly 20, and is affixed to the pedal. In this embodiment, the assembly 21 is biased toward the first engagement point 120. The spring wire assembly 20 provides bias to insure that the magnet is protruding and does not sag behind the front portion 104. The spring wire extending past the target magnet 21 acts as a stop when it touches the underside of the front portion 104 of the pedal. In a second embodiment, the target assembly is not biased, and simply extends outward from the mounting platform 14.

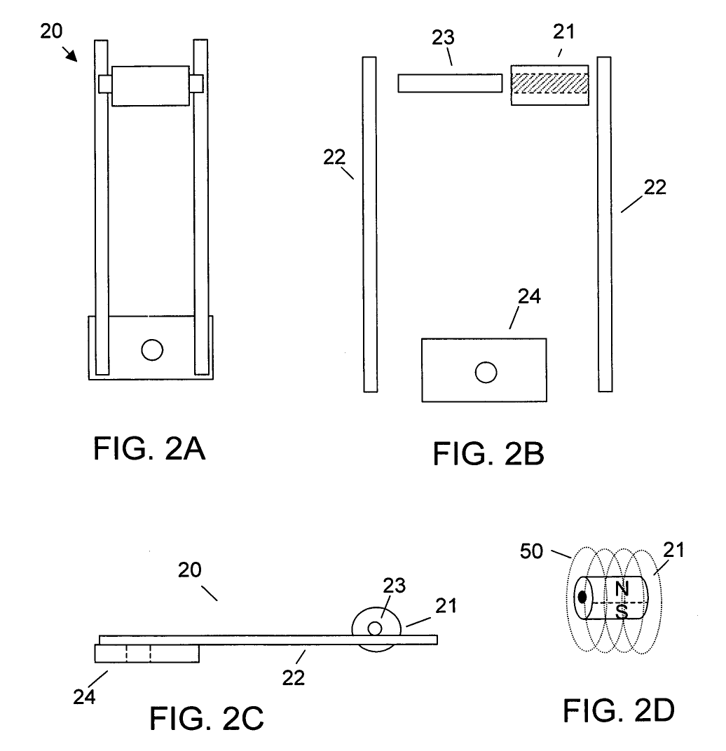

FIG. 2A shows the target assembly 20 of FIG. 1. The spring wire target structure in FIG. 2A is one embodiment that can be used to place the target magnet 21 in an optimal location for the purpose of attracting the cleat tip. Referring to FIG. 2B, the spring wire side frames 22 are affixed to a mounting plate 24, such as by welding or gluing. The spring wire sides 22 are spaced such that the inside dimension between them is slightly wider than the width of a cylindrical magnet used as the target magnet 21 in this embodiment. FIG. 2d shows a representative illustration of a target magnet 21 for use in this embodiment. The magnet retaining bar 23 is fed through the center hole of the cylindrical magnet 21 with equal lengths protruding from each end. The magnet retaining bar 23 is affixed to the spring wire side frames 22 at a predetermined distance from the distal end. The bar 23 can be affixed by welding, or can be passed through holes in the side frames 22. The location for attaching the magnet retaining bar 23 to the spring wire sides 22 is determined by measuring and calculating the distance from the ideal magnet target location to the mounting platform 14 such that the magnet target will reside within the tolerance area for the first engagement point. The magnetic target 21 thus will be at an optimal location for aligning shoe cleat tip to the first engagement point. To prevent the arms 22 from being hyper-extended when the cleat 13 is being disengaged from the capture cage, the suspension assembly 20 shown in FIG. 2A depicts the spring wire frame extending past the magnet retaining bar 23. Thus, the frame serves as a stop.

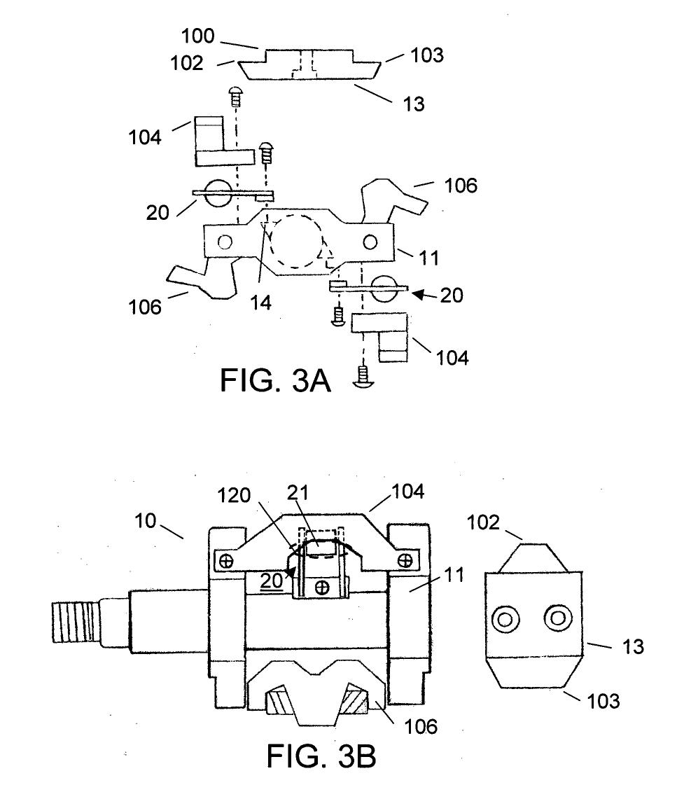

FIG. 3A is a side view of the embodiment of FIG. 1, with the addition of the pivoting rear portion 106. As was described in reference to FIG. 2, target magnet 21 is placed on an assembly 20, which allows it to be in the engagement point. This figure also show pivoting rear portion 106, which snaps into place after cleat 13 is properly engaged. FIG. 3B is a top view of this embodiment, where it can be seen that target magnet 21 is located below front portion 104 in the first engagement point 120.

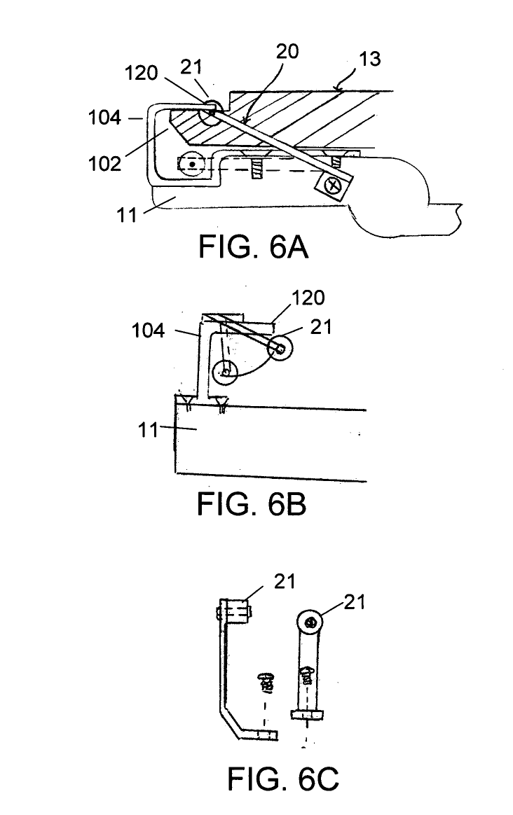

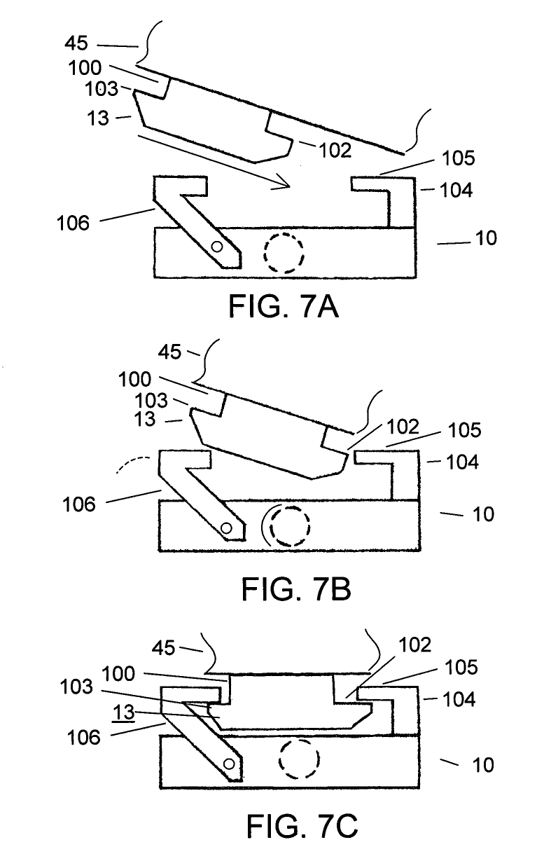

FIG. 6A shows another embodiment of the present invention. In this embodiment, assembly 20 is biased against front portion 104. Engagement of the cleat 13 moves the target magnet 21 to its stowed position (shown in dotted lines). After the cleat 13 is disengaged, the biasing element moves the target magnet 21 back to its operative position.

FIG. 6B shows another embodiment, where the pivot and mounting location of the target assembly is moved from the pedal base to the front portion 104 of the retaining mechanism. Again, the target magnet 21 is preferably biased so as to extend into the first engagement point 120. When the cleat 13 is inserted into the pedal, the target magnet 21 moves to the stowed position (shown in dotted lines).

FIG. 6C shows an alternative embodiment of the spring assembly. This is a simple equivalent of the spring wire frame shown in FIG. 2. A piece of spring steel is shaped and a target magnet 21 is affixed to it. This assembly is then mounted on mounting platform 14. The natural bias of the steel helps it retain its desired position and shape.

It should be noted that although the above disclosure describes embodiments in which the target magnet 21 is located on the pedal, the invention is not so limited. It is also possible to place the magnetic material in the tab of the cleat 13, which enters the fixed retaining element. In this scenario, a ferrous material, or a second magnet, is used in the pedal. Such a configuration would preferably require that the remainder of the pedal be made from non-ferrous materials.

What is claimed is:

1. A clipless bicycle pedal system comprising:
a. A cleat for attachment to a shoe, having a first tab comprising a magnetic material and a second tab;
b. A bicycle pedal comprising a first retaining element adapted to hold said first tab in place and a second retaining element adapted to hold said second tab in place; and
c. A magnetic material located near said first retaining element.

2. The system of claim 1, wherein said first tab comprises the front tab of said cleat.

3. The system of claim 1, wherein said first retaining element is fixed and said second retaining element is pivotable.

4. The system of claim 1, wherein said first retaining element comprises a space into which said first tab is inserted.

5. The system of claim 4, wherein said magnetic material is located in said space.

6. The system of claim 4, wherein said magnetic material is affixed to a movable element, wherein said movable element is biased so as to position said magnetic material in said space.

7. The system of claim 6, wherein said magnetic material is moved to a stowed position when said first tab is inserted in said space.

8. A clipless bicycle pedal comprising:
a. A bicycle pedal comprising a first retaining element adapted to hold a first tab of a cleat in place and a second retaining element adapted to hold a second tab of a cleat in place, wherein said first tab comprises a magnetic material; and
b. A magnetic material located near said first retaining element.

9. The system of claim 8, wherein said first tab comprises the front tab of said cleat.

10. The system of claim 8, wherein said first retaining element is fixed and said second retaining element is pivotable.

11. The system of claim 8, wherein said first retaining element comprises a space into which said first tab is inserted.

12. The system of claim 11, wherein said magnetic material is located in said space.

13. The system of claim 11, wherein said magnetic material is affixed to a movable element, wherein said movable element is biased so as to position said magnetic material in said space.

14. The system of claim 13, wherein said magnetic material is moved to a stowed position when said first tab is inserted in said space.

15. A method of securing a shoe to a clipless pedal, comprising:
a. Providing a cleat, attached to said shoe, wherein said cleat has a first and second tab, and said first tab comprises a magnetic material;
b. Providing a clipless pedal comprising first and second retaining elements, where said first retaining element is adapted to retain said first tab, and said first retaining element comprises a magnetic material;
c. Moving said shoe toward said first retaining element;
d. Having the magnetic field between said first retaining element and said first tab draw said first tab toward said first retaining element;
e. Engaging said first tab with said first retaining element; and
f. Engaging said second tab with said second retaining element subsequent to said engagement of said first tab.

16. The method of claim 15, whereby said first retaining element is fixed and said second retaining element is pivotable.

17. The method of claim 15, whereby said first tab comprises the front tab of said cleat.

18. The method of claim 15, whereby said first retaining element comprises a space into which said first tab is inserted, further comprising locating said magnetic material in said space.

19. The method of claim 18, wherein said magnetic material is affixed to a movable element, and further comprising biasing said movable element so as to position said magnetic material in said space.

20. The system of claim 19, further comprising moving said magnetic material to a stowed position when said first tab is inserted in said space.
